(19) United States
(12) Patent Application Publication
(10) Pub. No.: US 2019/0098347 A1
(43) Pub. Date: Mar. 28, 2019

(54) SYSTEM AND METHOD FOR REMOTE RADIOLOGY TECHNICIAN ASSISTANCE

(71) Applicant: General Electric Company, Schenectady, NY (US)

(72) Inventors: Vinay Chaugule, Bangalore (IN); Bellary Madhusudan Rao, Bangalore (IN)

(21) Appl. No.: 15/714,299

(22) Filed: Sep. 25, 2017

(51) Int. Cl. H04N 21/2343; H04N 21/4728; H04N 21/239; H04N 21/44; H04N 21/2385; H04N 21/61; H04N 21/4223; H04N 21/2187

(52) U.S. Cl. CPC H04N 21/234345; H04N 21/4728; H04N 21/2393; H04N 21/234363; G06F 19/321; H04N 21/2385; H04N 21/6125; H04N 21/4223; H04N 21/2187; H04N 21/44016

(57) ABSTRACT

A method includes receiving, at a first processor, an input transmitted over a low bandwidth communications channel from a second processor remotely located from the first processor, wherein the input includes a size of a region of interest (ROI) of a video frame and a desired video quality for the video frame outside the ROI. The method includes transmitting over the channel from the first processor to the second processor the ROI from an original video frame at a first resolution and the original video frame at a second resolution to reduce bandwidth usage, wherein the first resolution is greater than the second resolution. The method includes receiving, at the second processor, the ROI from the original video frame and the original video frame. The method includes displaying a composite video frame with the ROI at the first resolution and a region outside the ROI at the second resolution.

### BACKGROUND

The subject matter disclosed herein relates to medical imaging and, in particular, to providing remote assistance for medical imaging.

It is becoming more common for medical imaging systems to be deployed in remote areas. However, these remote areas may not include enough skilled technicians to utilize the medical imaging systems. In addition, these remote areas may lack high bandwidth communication channels to facilitate receiving remote assistance (e.g., via an audio/video link). Thus, there is a need for providing remote assistance that can utilize low bandwidth communication channels.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In accordance with a first embodiment, a method for saving bandwidth for transmission of a live video is provided. The method includes receiving, at a first processor, an input transmitted over a low bandwidth communications channel from a second processor remotely located from the first processor, wherein the input includes a size of a region of interest (ROI) of a video frame of the live video and a desired video quality for the video frame outside the ROI. The method also includes transmitting, via a transmitter, over the low bandwidth communication channel from the first processor to the second processor the ROI from an original video frame at a first resolution of the live video and the original video frame at a second resolution of the live video, wherein the first resolution is greater than the second resolution. The method also includes receiving, at the second processor, the ROI from the original video frame at the first resolution and the original video frame at the second resolution. The method further includes displaying, on a display coupled to the second processor, a composite video frame of the live video with the ROI at the first resolution and a region outside the ROI at the second resolution.

In accordance with a second embodiment, a method for saving bandwidth for transmission of a live video of a medical imaging procedure is provided. The method includes receiving, at a first processor, an input transmitted over a low bandwidth communications channel from a second processor remotely located from the first processor, wherein the input includes a size of a region of interest (ROI) of a video frame of the live video, a desired sub-sampling factor for the video frame, and a location of the ROI. The method also includes transmitting, via a transmitter, over the low bandwidth communication channel from the first processor to the second processor the ROI from the video frame at a first resolution and a sub-sampled frame of the video frame at a second resolution, wherein the first resolution is greater than the second resolution. The method also includes receiving, at the second processor, the ROI from the video frame at the first resolution and the sub-sampled frame at the second resolution. The method further includes displaying, on a display coupled to the second processor, a composite video frame of the live video with the ROI at the first resolution and a region outside the ROI at the second resolution.

In accordance with a third embodiment, a system is provided. The system includes a first processor and a camera coupled to the first processor, wherein the camera is configured to capture a live video of a medical imaging procedure. The system also includes a transmitter coupled to the first processor, wherein the first processor, the camera, and the transmitter are located at a first location. The system further includes a second processor and a display coupled to the second processor, wherein the second processor and the display are located at the second location remote from the first location. The first processor is configured to receive an input transmitted over a low bandwidth communications channel from a second processor remotely located from the first processor, wherein the input includes a size of a region of interest (ROI) of a video frame of the live video, a desired sub-sampling factor for the video frame, and a location of the ROI. The first processor is also configured to transmit, via the transmitter, over the low bandwidth communication channel to the second processor the ROI from the video frame at a first resolution and a sub-sampled frame of the video frame at a second resolution, wherein the first resolution is greater than the second resolution. The second processor is configured to receive the ROI from the video frame at the first resolution and the sub-sampled frame at the second resolution. The second processor is configured to display, on a display, a composite video frame of the live video with the ROI at the first resolution and a region outside the ROI at the second resolution.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is schematic diagram of an embodiment of a remote radiology technician assistance system;

FIG. 2 is a flow chart of an embodiment of a method for providing remote radiology technician assistance;

FIG. 3 is a representation of an original video frame;

FIG. 4 is a representation of a sub-sampled frame of the original video frame of FIG. 3;

FIG. 5 is a representation of a region of interest (ROI) from the original video frame of FIG. 3;

FIG. 6 is a representation of an embodiment of a composite video frame generated from the sub-sampled frame and the region of interest of FIGS. 4 and 5, respectively;

FIG. 7 is a representation of an embodiment of a composite video frame including track bars or sliders to select ROI size and image quality; and

FIG. 8 is a graphical representation of a bandwidth usage savings relative to ROI size and sub-sampling factor.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

Disclosed herein are systems and methods for providing remote radiology technician assistance over a low bandwidth communication channel (e.g., low bandwidth audio-video channel over the Internet). In certain embodiments, a camera takes live continuous video of a site where the medical imaging system is being utilized and transmits it to a remote site over a low bandwidth communication channel (e.g., data transfer rate of less than 500 kilobits per second (Kbps). A person (e.g., radiology technician or radiologist) at the site remote from the location where the medical imaging system is being utilized provides a desired size and location of a region of interest (ROI) in a video frame of the live video and a desired video quality (e.g., sub-sampling factor, desired video compression, removal of certain number of video frames, etc.) for a region of the video frame outside the ROI. In response, the frame of the live video is provided (e.g., continuously) to the remote site with both the ROI in the video frame in high resolution (e.g., the resolution at which the video is captured) and the original frame at a lower resolution (e.g., sub-sampled frame based on sub-sampling factor). At the remote site, the sub-sampled original frame may be interpolated (e.g., up-sampled) to its original size and the high resolution ROI overlaid for display of the frame of the live video with the ROI at a high resolution and the rest of the frame outside the ROI at a lower resolution. In certain embodiments, the ROI may be selected or changed by the person located at the remote site. The disclosed embodiments enable a two to six times reduction in bandwidth usage with minimal computational overhead to enable a technician or radiologist to provide remote assistance to a site lacking a skilled technician or radiologist during an imaging procedure with a medical imaging system (e.g., computed tomography system, magnetic resonance imaging system, X-ray system, ultrasound system, etc.).

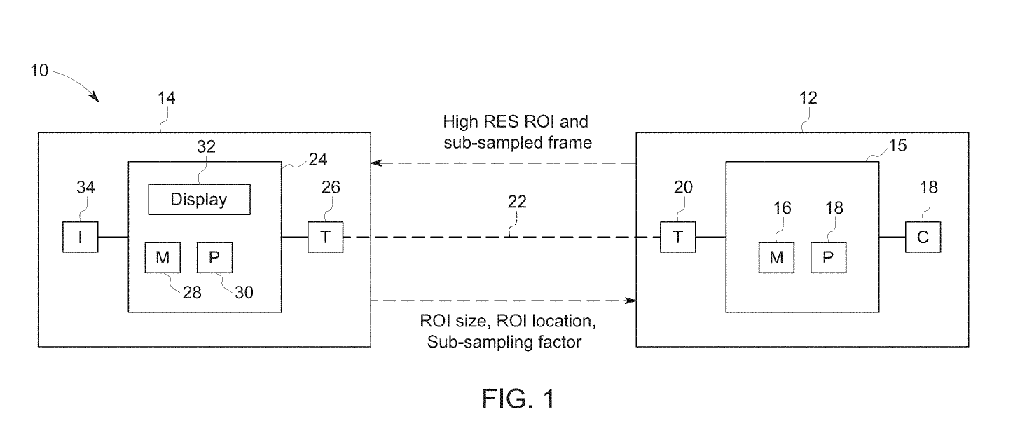

FIG. 1 is schematic diagram of an embodiment of a remote radiology technician assistance system 10. As discussed in greater detail below, the system 10 enables a skilled technician or radiologist (located at a site remote from an imaging operation) to provide assistance to a technician conducting the imaging operation over a low bandwidth communication channel (e.g., less than 500 Kbps) over a network (e.g., Internet). It should be noted that the system 10 and techniques may be utilized for any type of imaging such as computed tomography imaging, magnetic resonance imaging, X-ray imaging, ultrasound imaging, etc. In addition, the system 10 and techniques may be utilized for non-imaging medical application and/or non-medical applications. Further the system and techniques may be utilized across different modalities (e.g., security, tele-conferencing, etc.). In certain embodiments, the system 10 may be deployed over a cloud platform to take care of secured communication needs.

The system 10 includes a first location 12 (e.g., transmitter location) where the imaging operation takes place and a second location 14 (e.g., remote viewer location) located remote from the first location. For example, the locations may be different cities, provinces, countries, etc. The first location 12 includes a computing device 15 (e.g., computer, tablet, smartphone, etc.) having a memory 16 and a processor 18 to execute code or instructions stored within the memory 16. The computing device 15 is coupled to a camera 18. The camera 18 is directed at the site of the imaging operation and is configured to continuously capture live video of the imaging operation in real time. The video captured by the camera 18 is transmitted by the computing device 15, via a transmitter/receiver 20 coupled to the computing device, over a low bandwidth communication channel 22 (e.g., less than 500 Kbps) over a network (e.g., Internet) to the second location 14. In particular, the second location 14 includes a computing device 24 (e.g., computer, tablet, smartphone, etc.) that receives the video from the first location 12 via a transmitter/receiver 26 coupled to the computing device 24. The computing device 24 includes a memory 28 and a processor 30 to execute code or instructions stored within the memory 28. The computing device 24 also includes a display 32 to display the received video and/or a composite thereof from the first location 12. The display 32 may also display recommendations generated by the computing device 24 (e.g., recommended ROI location, recommended ROI size, recommended video quality (e.g., sub-sampling factor, video compression level, number of video frames to remove, etc.) for region outside ROI, etc.) based on the transmission/reception speed of the channel 22 or sliders or trackers to enable a user to select ROI size and/or video quality. The computing device 24 is also coupled to an input device 34. The input device 34 may include a mouse, a keyboard, a user wearable eye tracking device, or any other device that enables a user to interact with the computing device 24 to facilitate providing remote radiology technician assistance (e.g., provide inputs regarding ROI location, ROI size, and/or video quality outside the ROI).

The instructions stored on the memories 16, 28 may be encoded in programs or codes stored in a tangible non-transitory computer-readable medium. The memories 16, 28 may include a computer readable medium, such as, without limitation, a hard disk drive, a solid state drive, diskette, flash drive, a compact disc, a digital video disc, random access memory (RAM), and/or any suitable storage device that enables the processors 18, 30 to store, retrieve, and/or execute instructions and/or data. The processors 18, 30 may be a general purpose processor (e.g., processor of a desktop/laptop computer), system-on-chip (SoC) device, or application-specific integrated circuit, or some other processor configuration. The processors 18, 30 may execute instructions to determine a recommended ROI location, ROI size, and/or video quality outside the ROI (e.g., sub-sampling factor) within an original video frame of the captured video based on the transmission/reception speed of the channel 22. In addition, the processor 18 is configured to transmit the original video (e.g., continuous video frames) as captured and/or the ROI in high resolution (e.g., resolution as originally captured) and the sub-sampled frame of the original video frame at a lower resolution than the ROI and/or at a smaller size (e.g., smaller frame size than the original frame size). The processor 18 is also configured to generate the sub-sampled frame (e.g., based on a received desired image quality such as sub-sampling factor). The processor 30 is configured to receive and transmit inputs as to the ROI location, ROI size, and/or desired video quality outside the ROI. The processor 30 is also configured to receive the ROI in high resolution (e.g., resolution as originally captured) and the sub-sampled frame of the original video frame at a lower resolution than the ROI and/or at a smaller size (e.g., smaller frame size than the original frame size), interpolate the sub-sampled frame, and overlay the ROI on the interpolated frame to generate a composite video frame with the ROI at a high resolution and the region outside the ROI at a lower resolution to save bandwidth. The system 10 enables a two to six times reduction in bandwidth usage with minimal computational overhead to enable a technician or radiologist to provide remote assistance to a site (e.g., the first location 12) lacking a skilled technician or radiologist during an imaging procedure with a medical imaging system (e.g., computed tomography system, magnetic resonance imaging system, X-ray system, ultrasound system, etc.).

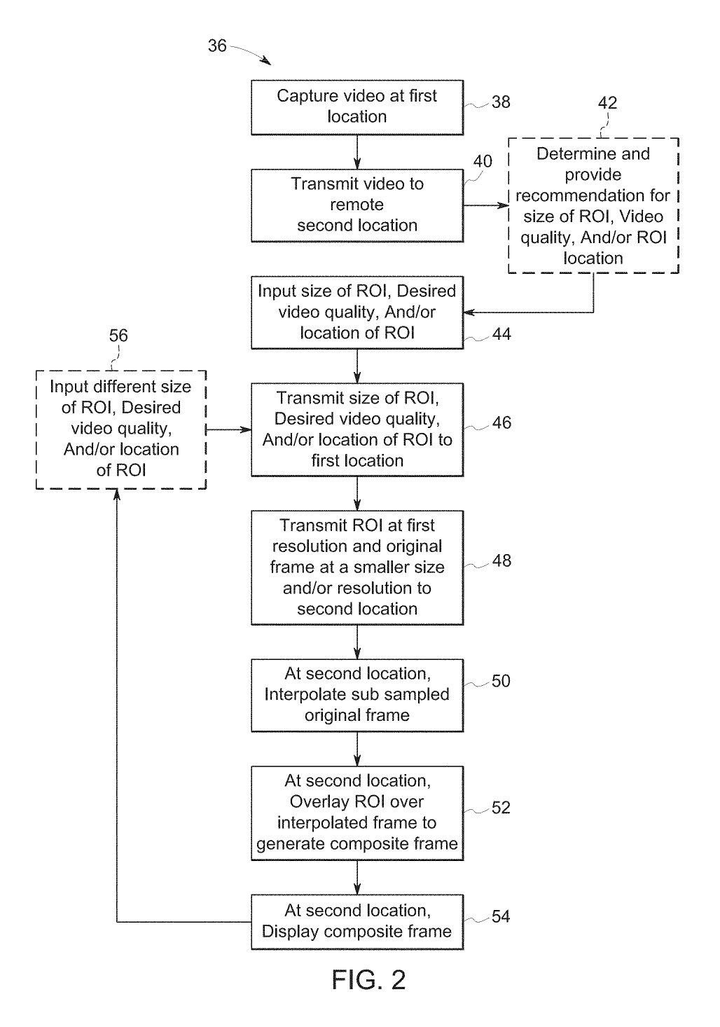

FIG. 2 is a flow chart of an embodiment of a method 36 for providing remote radiology technician assistance. One or more the steps of the method 36 may be performed in a different order and/or simultaneously. Also, one or more of the steps may be performed by the computing devices 15, 24. The method 36 includes capturing video, via the camera 18, of the medical imaging operation (block 38). The method 36 also includes transmitting (e.g., continuously frame by frame), via the transmitter, the captured video to the second location 14 (block 40). Frames are continuously transmitted to provide the video live or in real time to the second location 14. The captured video may be initially transmitted at full resolution or at a lower resolution. Alternatively, the captured video may be initially transmitted with a ROI at a high resolution (e.g., the original resolution at capture) and the original video frame at a lower video quality (i.e., lower resolution (than the ROI) and/or a smaller size (e.g., smaller frame size than the original frame size)) with the ROI and the video quality for the rest of frame initially automatically determined (e.g., dynamically determined) by one of the computing devices 15, 24. In certain embodiments, the method 36 includes determining and providing recommendations for the size of the ROI, video quality, and/or location of the ROI (block 42). This may be determined by one of the computing device 15, 24. The recommendations may be displayed on the display 32. The method 36 further includes the user at the second location 14 inputting (e.g., via the input device 34) a size of the ROI, desired video quality (e.g., sub-sampling factor), and/or location of the ROI (block 44). In certain embodiments, the video frame being displayed on the display may include track bars or sliders to enable the size of the ROI and the desired video quality to be selected (e.g., to enable manual selection by the user). In certain embodiments, the user may select a location of the ROI via the input device 34 to serve as the ROI (e.g., via a click of a mouse, tracking eye movement of the user to a desired point, etc.). Sub-sampling reduces or avoids computational overhead. In certain embodiments, the user may be able to select multiple ROIs. In certain embodiments, the user may be able to change modes between a dynamic (e.g., letting the computing device determine the video quality based on dynamic transmission/reception speeds on the channel) or manual (e.g., via the tracker) selection of the video quality. Upon inputting the selections, the method 36 includes transmitting (e.g., via transmitter 26) the size of the ROI, desired video quality (e.g., sub-sampling factor), and/or location of the ROI to the computing device 15 at the first location 12 (block 46). In response, the method 36 includes the video being continuously transmitted frame by frame to the second location 14 by transmitting the ROI at a high resolution (e.g., the original resolution at capture) and the original video frame at a lower video quality (i.e., lower resolution (than the ROI) and/or at a smaller size (e.g., smaller frame size than the original frame size)) (block 48). In certain embodiments, video compression techniques may be employed in addition to sub-sampling to further reduce bandwidth usage. For example, Motion-JPEG (MJPEG), which is the standard video compression format with wide applications (e.g., IP cameras, webcams, streaming servers), may be utilized. The method 36 includes, via the computing device 24 at the second location 14, interpolating the smaller sized lower resolution video frame to the original size of the original video frame (block 50). The method 36 also includes, at the second location 14, overlaying the high resolution ROI over the lower resolution interpolated frame to generate a composite video frame having the high resolution ROI and the area outside the ROI having a lower resolution (block 52). The method 36 further includes displaying (e.g., continuously displaying frame after frame in real time) the composite frame on the display 32 (block 54). In certain embodiments, the method 36 includes the user inputting a different ROI size, a different desired video quality, and/or a different ROI location via the input device 34 (block 56) upon which steps 46 through 54 are repeated based upon the inputted changes.

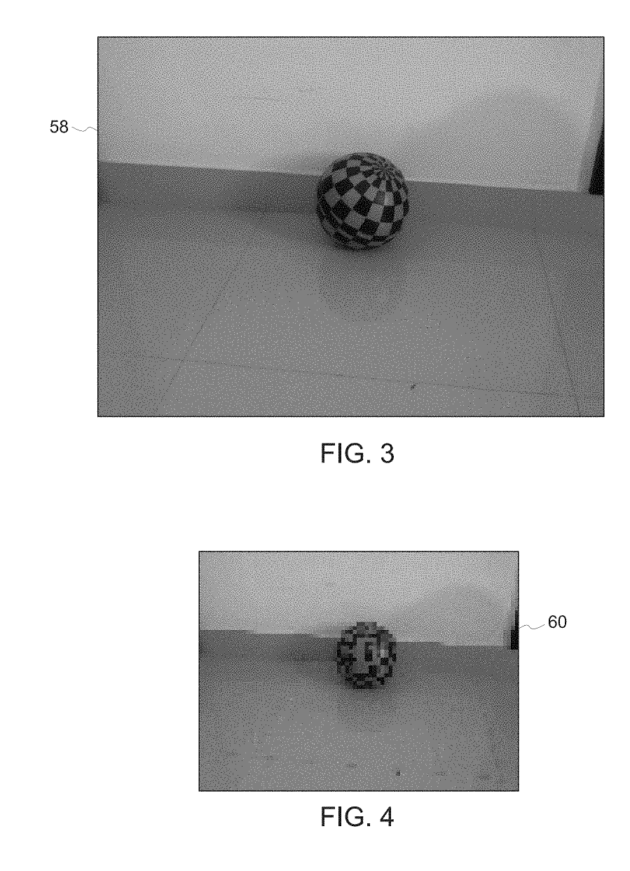

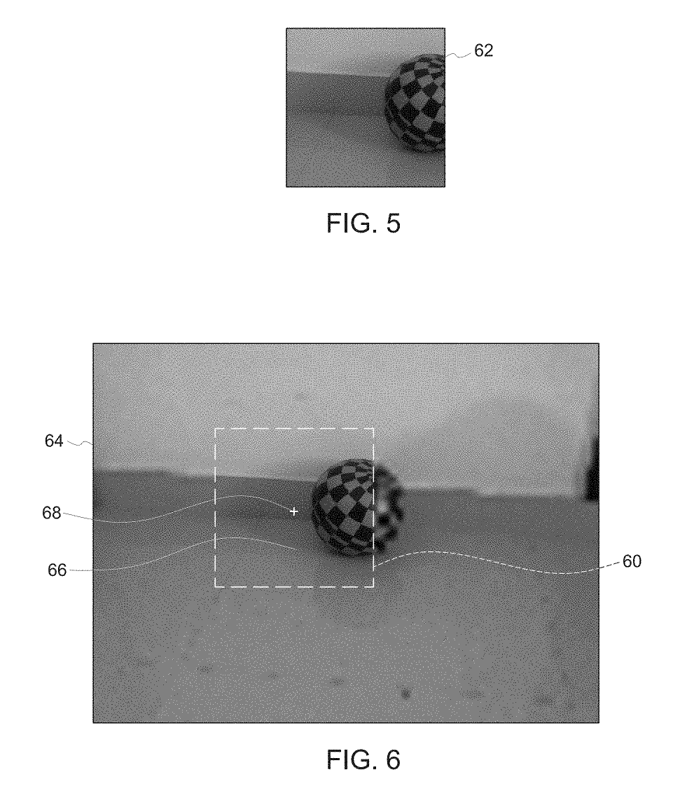

FIG. 3 is a representation of an original video frame 58 captured by the camera 18 at the first location 12 at its initial resolution (e.g., high resolution). As depicted, the original video frame size is 640 pixels×480 pixels. FIG. 4 is a representation of a sub-sampled frame 60 of the original video frame 58 of FIG. 3 sub-sampled with a sub-sampling factor of 8. The sub-sampled frame 60 is received from the first location 12 at the computing device 24 at the second location 14. The sub-sampled frame 60 is smaller in size than the original video frame 58. In addition, the sub-sampled frame 60 has a lower resolution than the original video frame 58. FIG. 5 is a representation of a ROI 62 from the original video frame 58 of FIG. 3. As depicted, the ROI 62 has a size of 200 pixels×200 pixels. The ROI 62 is received from the first location 12 at the computing device 24 at the second location 14. The ROI 62 has the same resolution as the original video frame 58. In certain embodiments, the ROI 62 may have a lower resolution than the resolution of the video at the time of capture but a resolution higher than the resolution of the sub-sampled frame 60. FIG. 6 is a representation of an embodiment of a composite video frame 64 generated from the sub-sampled frame 60 and the ROI 62. In particular, the ROI 62 is overlaid over an interpolated version of the sub-sampled frame 60 (e.g., increased in size to the original size of the original video frame 58). A box 66 indicates the ROI 62. The box 66 may or may not be displayed with the composite video frame 64. The region outside the box 66 has a lower resolution. A graphical indicator 68 may also be located on the ROI 62 indicating a central point of the ROI 62.

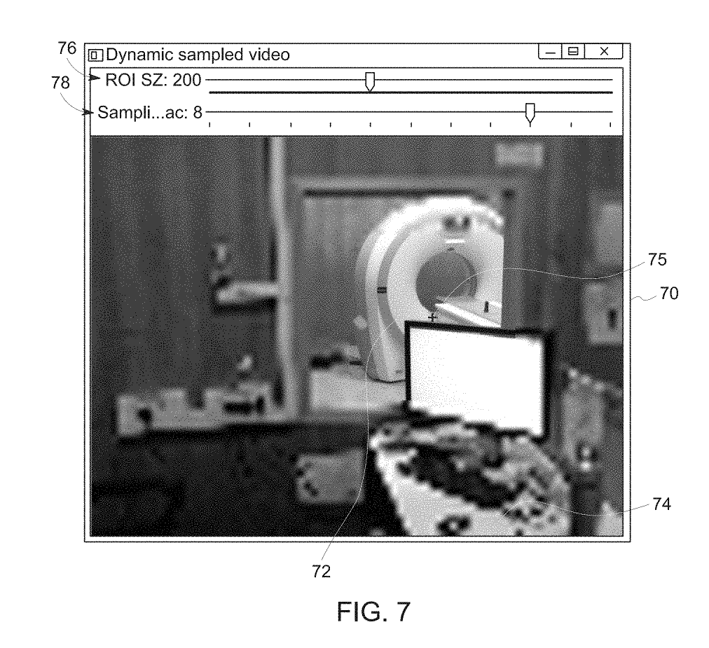

FIG. 7 is a representation of an embodiment of a composite video frame 70 (e.g., of an imaging operation with a medical imaging system (e.g., CT imaging system)) including track bars or sliders to select ROI size and image quality. FIG. 7 depicts an example of the composite video frame 70 that may be displayed on the display 32 of the second computing device 24 at the second location 14. The composite video frame 70 includes the ROI 72 (e.g., 200 pixels×200 pixels) having a higher resolution than the region 74 outside the ROI 72 (e.g., having sub-sampling factor of 8). The composite video frame 70 also includes a graphical indicator 75 indicating a central point of the ROI 72. The graphical indicator 75 can be an input from mouse pointer or augmented technology to track eye movement or anything similar. Above the composite video frame 70 are a first track bar or slider 76 for selecting the size of the ROI 72 and a second track bar or slider 78 for selecting the image quality (e.g., sub-sampling factor) for the region 74 of the video frame 70 outside the ROI 72. The ROI size and image quality may be selected via the input device 34 (e.g., mouse, keyboard, etc.). As described above, these inputs may be transmitted to the first location 12.

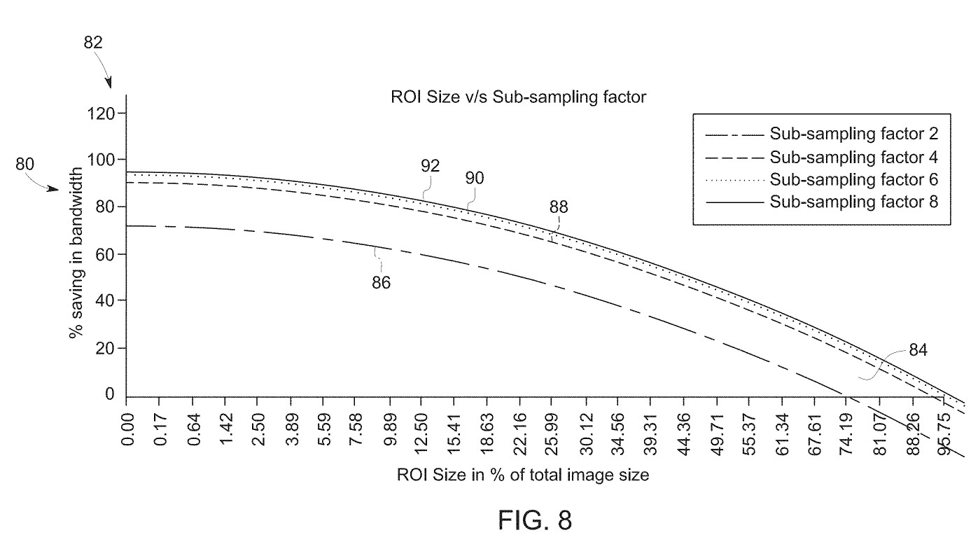

FIG. 8 is a graphical representation of a bandwidth usage savings relative to ROI size and sub-sampling factor. FIG. 8 depicts a graph 80 having an Y-axis 82 representing percentage saved in bandwidth and a X-axis 84 representing ROI size as a percentage of the total image size (e.g., in the absence of compression). Plots 86, 88, 90, 92 represent the sub-sampling factors 2, 4, 6, 8, respectively, relative to the Y- and X-axes 82, 84. As depicted in FIG. 8, as the sub-sampling factor is increased the percentage saved in bandwidth increases. For example, the composite video frame 70 of FIG. 7 may reduce bandwidth (in conjunction with compression, e.g., utilizing MJPEG) by over approximately 78 percent.

Technical effects of the disclosed embodiments include providing remote radiology technician assistance over a low bandwidth communication channel (e.g., low bandwidth audio-video channel over the internet). For example, a user at remote location may manually select a ROI size, video quality, and/or ROI location and provide it to the location where the imaging operation is being captured via video camera. The location where the imaging operation is occurring transmits over a low bandwidth communication channel the video continuously to the remote location in the form of a ROI in high resolution and a sub-sampled frame of the original video frame, where a composite video frame may be generated. Utilizing the disclosed embodiments, usage of bandwidth can be minimized. In addition, varying outputs (e.g., stuck frame, pixelated frames, frame loss, etc.) of the video quality due to low bandwidth may be avoided.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for saving bandwidth for transmission of a live video, comprising:
receiving, at a first processor, an input transmitted over a low bandwidth communications channel from a second processor remotely located from the first processor, wherein the input comprises a size of a region of interest (ROI) of a video frame of the live video and a desired video quality for the video frame outside the ROI;
transmitting, via a transmitter, over the low bandwidth communication channel from the first processor to the second processor the ROI from an original video frame at a first resolution of the live video and the original video frame at a second resolution of the live video, wherein the first resolution is greater than the second resolution, and the first resolution is the resolution at which the live video is captured; and
receiving, at the second processor, the ROI from the original video frame at the first resolution and the original video frame at the second resolution; and
displaying, on a display coupled to the second processor, a composite video frame of the live video with the ROI at the first resolution and a region outside the ROI at the second resolution.

2. The method of claim 1, wherein the original video frame at the second resolution received at the second processor is smaller in size than an initial size of the original video frame.

3. The method of claim 2, comprising, at the second processor, interpolating the original video frame at the second resolution received at the second processor to the initial size of the original video frame.

4. The method of claim 3, comprising, at the second processor, overlaying the ROI from the original frame at the first resolution received at the second processor onto the interpolated original video frame at the second resolution to generate the composite video frame.

5. The method of claim 1, wherein the desired video quality comprises a sub-sampling factor.

6. The method of claim 1, comprising:
receiving at the second processor, via an input device, a user input selecting a location of the ROI; and
transmitting the user input selecting the location of the ROI to the first processor.

7. The method of claim 6, wherein the input device comprises a mouse, keyboard, or a user wearable eye tracking device.

8. The method of claim 1, comprising:
at the second processor, automatically determining a recommended combination of ROI size and video quality for the video frame outside the ROI for the low bandwidth communications channel based on the low bandwidth communication channel's dynamic transmission and reception speeds;
and displaying the recommended combination on the display.

9. The method of claim 1, comprising continuously capturing the live video via a camera and transmitting, via the transmitter, the live video to the second processor over the low bandwidth communications channel.

10. The method of claim 1, comprising receiving a first user input on a first slider on the composite video frame to select the size of the ROI and second user input on a second slider on the composite video frame to select the desired video quality.

11. A method for saving bandwidth for transmission of a live video of a medical imaging procedure, comprising:
receiving, at a first processor, an input transmitted over a low bandwidth communications channel from a second processor remotely located from the first processor, wherein the input comprises a size of a region of interest (ROI) of a video frame of the live video, a desired sub-sampling factor for the video frame, and a location of the ROI;
transmitting, via a transmitter, over the low bandwidth communication channel from the first processor to the second processor the ROI from the video frame at a first resolution and a sub-sampled frame of the video frame at a second resolution, wherein the first resolution is greater than the second resolution, and the first resolution is the resolution at which the live video is captured; and
receiving, at the second processor, the ROI from the video frame at the first resolution and the sub-sampled frame at the second resolution; and
displaying, on a display coupled to the second processor, a composite video frame of the live video with the ROI at the first resolution and a region outside the ROI at the second resolution.

12. The method of claim 11, wherein the sub-sampled frame is smaller in size than an initial size of the video frame.

13. The method of claim 12, comprising, at the second processor, interpolating the sub-sampled frame to the initial size of the video frame to generate an interpolated video frame at the second resolution.

14. The method of claim 13, comprising, at the second processor, overlaying the ROI at the first resolution onto the interpolated video frame at the second resolution to generate the composite video frame of original size.

15. The method of claim 11, comprising:
receiving at the second processor, via an input device, a user input selecting the location of the ROI; and
transmitting the user input selecting the location of the ROI to the first processor.

16. The method of claim 15, wherein the input device comprises a mouse, keyboard, or a user wearable eye tracking device.

17. The method of claim 11, comprising:
at the second processor, automatically determining a recommended combination of ROI size and sub-sampling factor for the video frame for the low bandwidth communications channel based on the low bandwidth communication channel's dynamic transmission/reception speeds;
and displaying the recommended combination on the display.

18. The method of claim 11, comprising receiving a first user input on a first slider on the composite video frame to select the size of the ROI and second user input on a second slider on the composite video frame to select the sub-sampling factor.

19. A system, comprising:
a first processor;
a camera coupled to the first processor, wherein the camera is configured to capture a live video of a medical imaging procedure;
a transmitter coupled to the first processor, wherein the first processor, the camera, and the transmitter are located at a first location;
a second processor; and
a display coupled to the second processor, wherein the second processor and the display are located at a second location remote from the first location;
wherein the first processor is configured to:
receive an input transmitted over a low bandwidth communications channel from a second processor remotely located from the first processor, wherein the input comprises a size of a region of interest (ROI) of a video frame of the live video, a desired sub-sampling factor for the video frame, and a location of the ROI; and
transmit, via the transmitter, over the low bandwidth communication channel to the second processor the ROI from the video frame at a first resolution and a sub-sampled frame of the video frame at a second resolution, wherein the first resolution is greater than the second resolution, and the first resolution is the resolution at which the live video is captured; and
wherein the second processor is configured to:
receive the ROI from the video frame at the first resolution and the sub-sampled frame at the second resolution; and
display, on a display, a composite video frame of the live video with the ROI at the first resolution and a region outside the ROI at the second resolution.

20. The system of claim 19, wherein the second processor is configured to interpolate the sub-sampled frame to generate an interpolated video frame at the second resolution and to overly the ROI at the first resolution onto the interpolated video frame to generate the composite video frame.
